(19) United States
(12) Patent Application Publication
(10) Pub. No.: US 2007/0024574 A1
(43) Pub. Date: Feb. 1, 2007

(54) Liquid crystal display including phase locked loop circuit for controlling frequency of backlight driving signal

(75) Inventor: Hsi-Yao Wu, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/496,173

(22) Filed: Jul. 31, 2006

(30) Foreign Application Priority Data
Jul. 29, 2005 (TW) 94125773

(51) Int. Cl. G09G 3/36

(52) U.S. Cl. 345/102

(57) ABSTRACT

An liquid crystal display (LCD) (200) includes an LCD panel (210), a timing control circuit (230), and a backlight module 250. The LCD panel includes a gate drive integrated circuit (IC) (211) and a data drive IC (212) formed thereon for driving the LCD panel. The backlight module includes a backlight (256), an inverter (252), an inverter drive IC (255), a voltage feedback circuit (253), and a phase locked loop (PLL) circuit (254). The timing control circuit receives a synchronized input signal and generates a timing control signal for controlling gate drive IC and the data drive IC according to the synchronized input signal. The PLL circuit receives the synchronized input signal and provides a backlight synchronized signal to the inverter drive IC according to the synchronized input signal. The inverter drive IC controls a frequency of the backlight driving signal according to the backlight synchronized signal.

### FIELD OF THE INVENTION

The present invention relates to a liquid crystal display (LCD) which includes a phase locked loop circuit for controlling a frequency of a signal used to drive a backlight of the LCD.

### GENERAL BACKGROUND

An LCD has the advantages of portability, low power consumption, and low radiation, and has been widely used in various portable information products such as notebooks, personal digital assistants (PDAs), video cameras and the like. Furthermore, the LCD is considered by many to have the potential to completely replace CRT (cathode ray tube) monitors and televisions.

FIG. 5 is a schematic diagram of a typical LCD. The LCD 100 includes an LCD panel 110, a timing control circuit 130, and a backlight module 150. The LCD panel 110 includes a gate drive integrated circuit (IC) 111 and a data drive IC 112, which are used for driving the LCD panel 110. The backlight module 150 includes a backlight 156, an inverter 152, an inverter drive IC 155, and a voltage feedback circuit 153. The backlight 156 is typically a cold cathode fluorescent lamp (CCFL).

The timing control circuit 130 receives a synchronized input signal from an external circuit 132, and generates a control signal for controlling the gate drive IC 111 and the data drive IC 112 according to the synchronized input signal. The inverter 152 generates a backlight driving signal, which is an alternating current (AC) signal, for driving the backlight 156. The inverter drive IC 155 is used to control the backlight driving signal of the inverter 152. The voltage feedback circuit 153 is used to feedback a voltage width message of the backlight driving signal from the inverter 152 back to the inverter drive IC 155.

The LCD 100 displays images on the LCD panel 110 at a first predetermined frequency, such as one of the frequences of 60 Hz (hertz), 75 Hz, and 85 Hz, according to the synchronized input signal. The backlight 156 illumilates the LCD panel 110 at a second predetermined frequency, such as 2000 Hz, according to the backlight driving signal. Because the first predetermined frequency is not synchronized with the second predetermined frequency, the display quality of the LCD 100 can be degraded by a difference between the first predetermined frequency and the second predetermined frequency.

It is desired to provide an LCD which overcomes the above-described deficiencies.

### SUMMARY

An LCD includes an LCD panel, a timing control circuit, and a backlight module. The LCD panel includes a gate drive IC and a data drive IC for driving the LCD panel. The backlight module includes a backlight, an inverter, an inverter drive IC, a voltage feedback circuit, and a phase locked loop (PLL) circuit. The timing control circuit receives a synchronized input signal, and generates a timing control signal for controlling gate drive IC and the data drive IC according to the synchronized input signal. The inverter generates a backlight driving signal for driving the backlight. The voltage feedback circuit transmits the voltage width message of the backlight driving signal back to the inverter drive IC. The PLL circuit receives the synchronized input signal and receives a frequency message of the backlight driving signal via the phase feedback circuit, and provides a backlight synchronized signal to the inverter drive IC according to the synchronized input signal and the frequency message of the backlight. The inverter drive IC controls a frequency of the backlight driving signal according to the backlight synchronized signal.

Advantages and novel features of the LCD including the above-described circuits will become more apparent from the following detailed description when taken in conjunction with the accompanying drawings.

### BRIEF DESCRIPTION OF THE DRAWINGS

FIG. 1 is a schematic diagram of an LCD according to a first embodiment of the present invention, the LCD including a phase locked loop (PLL) circuit.

FIG. 2 is a schematic diagram of the PLL circuit of FIG. 1, and of certain other circuits and components connected with the PLL circuit.

FIG. 3 is a schematic diagram of an LCD according to a second embodiment of the present invention.

FIG. 4 is a schematic diagram of an LCD according to a third embodiment of the present invention.

FIG. 5 is a schematic diagram of a conventional LCD.

### DETAILED DESCRIPTION OF PREFERRED EMBODIMENTS

Reference will now be made to the drawings to describe the present invention in detail.

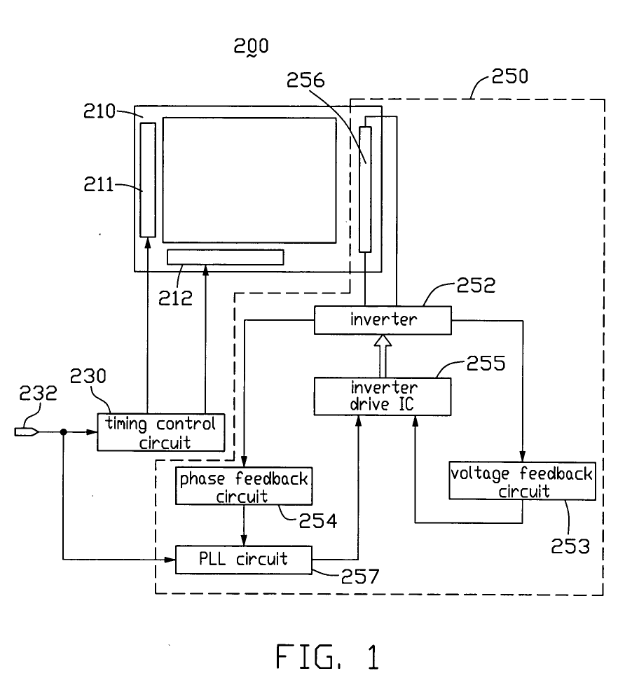

Referring to FIGS. 1 and 2, an LCD 200 according to a first embodiment of the present invention includes an LCD panel 210, a timing control circuit 230, and a backlight module 250. The LCD panel 210 includes a gate drive IC 211 and a data drive IC 212, which are used for driving the LCD panel 210. The backlight module 250 includes a backlight 256, an inverter 252, an inverter drive IC 255, a voltage feedback circuit 253, a phase feedback circuit 254, and a phase locked loop (PLL) circuit 257. The PLL circuit 257 includes a phase comparator 2571, a voltage controlled oscillator (VCO) 2572, and a phase focus 2573. The phase focus 2573 includes a frequency control terminal 2574. The backlight 256 is typically a cold cathode fluorescent lamp (CCFL).

The timing control circuit 230 receives a synchronized input signal from an external circuit 232, and generates a timing control signal for controlling the gate drive IC 211 and the data drive IC 212 according to the synchronized input signal. The LCD panel 210 displays images at a predetermined frequency, such as one of the frequencies of 60 Hz, 75 Hz and 85 Hz, according to the synchronized input signal.

The inverter 252 generates a backlight driving signal for driving the backlight 256. The backlight driving signal is an alternating current (AC) signal, which includes a frequency message and a voltage width message.

The inverter drive IC 255 controls the backlight driving signal of the inverter 252. The voltage feedback circuit 253 transmits the voltage width message of the backlight driving signal back to the inverter drive IC 255 from the inverter 252.

The PLL circuit 257 receives the synchronized input signal from the external circuit 232, and receives the frequency message of the backlight driving signal via the phase feedback circuit 254. Then, the PLL circuit 257 provides a backlight synchronized signal to the inverter drive IC 255. The inverter drive IC 255 controls a frequency of the backlight driving signal according to the backlight synchronized signal. Thus the frequency of the backlight driving signal is synchronized with the frequency of the synchronized input signal.

The internal operational principle of the PLL circuit 257 is as follows. The phase focus 2573 receives the frequency message of the backlight driving signal via the phase feedback circuit 254, generates a phase-division signal according to the frequency message of the backlight driving signal, and supplies the phase-division signal to the phase comparator 2571. The phase comparator 2571 compares the phase-division signal with the synchronized input signal to achieve a comparison result, and generates an adjusting signal according to the comparison result. Then the phase comparator 2571 supplies the adjusting signal to the VCO 2572. The VCO 2572 generates a backlight synchronized signal according to the adjusting signal, and supplies the backlight synchronized signal to the inverter drive IC 255.

The frequency of the backlight synchronized signal is N times as large as that of the phase-division signal, and the frequency of the phase-division signal is the same as that of the synchronized input signal, wherein N is a positive whole number. The frequency control terminal 2574 of the phase focus 2573 is used to change a value of N, which is generally in the range from 1-20.

In summary, the LCD 200 includes a PLL circuit 257, which provides a backlight synchronized signal to the inverter drive IC 255. The inverter drive IC 255 controls the frequency of the backlight driving signal according to the backlight synchronized signal, whereby the frequency of the backlight driving signal is synchronized with the frequency of the synchronized input signal. Consequently, the backlight 256 illuminates the LCD panel 210 at a frequency synchronized with the predetermined frequency at which the LCD panel 210 displays images. Thus, the display quality of the LCD 200 is improved.

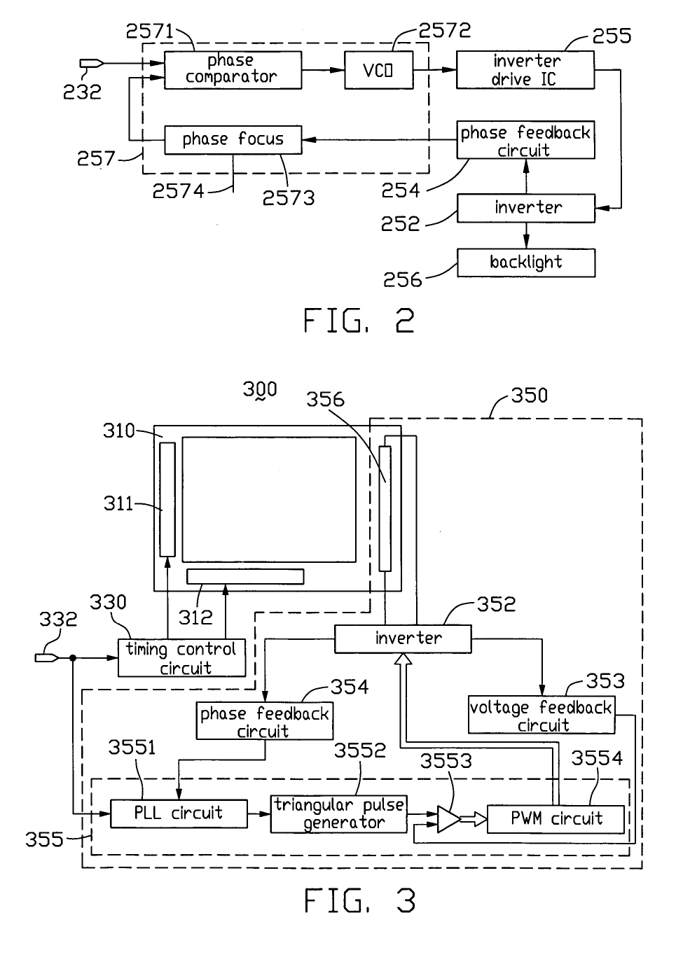

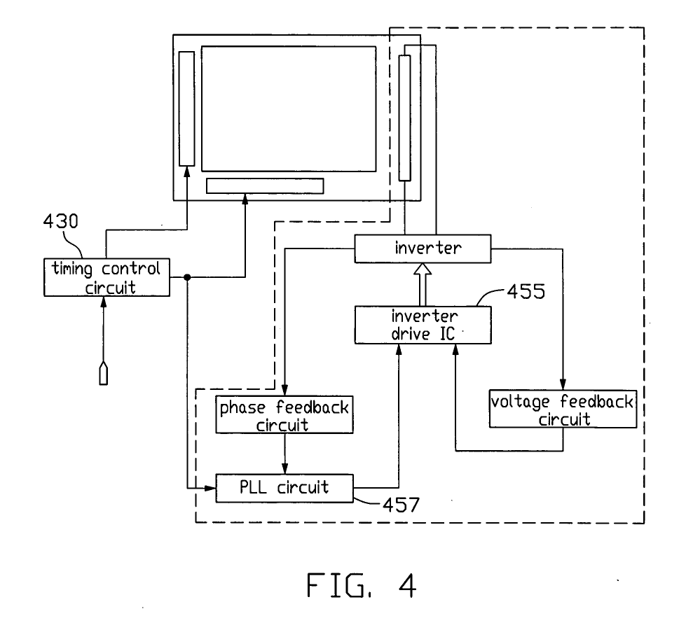

FIG. 3 is a schematic diagram of an LCD according a second embodiment of the present invention. The LCD 300 includes an LCD panel 310, a timing control circuit 330, and a backlight module 350. The LCD panel 310 includes a gate drive IC 311 and a data drive IC 312, which are used for driving the LCD panel 310. The backlight module 350 includes a backlight 356, an inverter 352, an inverter drive IC 355, a voltage feedback circuit 353, and a phase feedback circuit 354. The inverter drive IC 355 includes a PLL circuit 3551, a triangular pulse generator 3552, a controller 3553, and a PWM circuit 3554 for driving the inverter 352. The internal circuitry and functions of the PLL circuit 3551 are essentially the same as those of the PLL circuit 257 described above.

The timing control circuit 330 receives a synchronized input signal from an external circuit 332, and generates a timing control signal for controlling the gate drive IC 311 and the data drive IC 312 according to the synchronized input signal. The LCD panel 310 displays images at a predetermined frequency, such as one of the frequencies of 60 Hz, 75 Hz, and 85 Hz, according to the synchronized input signal.

The inverter 352 generates a backlight driving signal for driving the backlight 356. The backlight driving signal is an alternating current (AC) signal, which includes a frequency message and a voltage width message. The inverter drive IC 355 controls the backlight driving signal of the inverter 352. The voltage feedback circuit 353 transmits the voltage width message of the backlight driving signal from the inverter 352 back to the inverter drive IC 355.

The PLL circuit 3551 receives the synchronized input signal from the external circuit 332, and receives the frequency message of the backlight driving signal via the phase feedback circuit 354. Then the PLL circuit 3551 generates a backlight synchronized signal according to the synchronized input signal and the frequency message of the backlight driving signal, and supplies the backlight synchronized signal to the triangular pulse generator 3552. The triangular pulse generator 3552 generates a triangular pulse signal according to the backlight synchronized signal, and supplies the triangular pulse signal to the controller 3553. The controller 3553 drives the PWM circuit 3554 according to the triangular pulse signal. The PWM circuit 3554 thereby controls a frequency of the backlight driving signal generated by the inverter 352. Thus the frequency of the backlight driving signal is synchronized with the frequency of the synchronized input signal.

Because the functions of the PLL circuit 3551 are essentially the same as those of the PLL circuit 257, the frequency of the backlight synchronized signal can be automatically adjusted to a value which is N times as large as a value of the frequency of the synchronized input signal. N is a positive whole number, and is generally in the range from 1-20. The PLL circuit 3551 is integrated in the inverter drive IC 355, so that a volume of the backlight module 350 is more compact than that of the backlight module 250 described above.

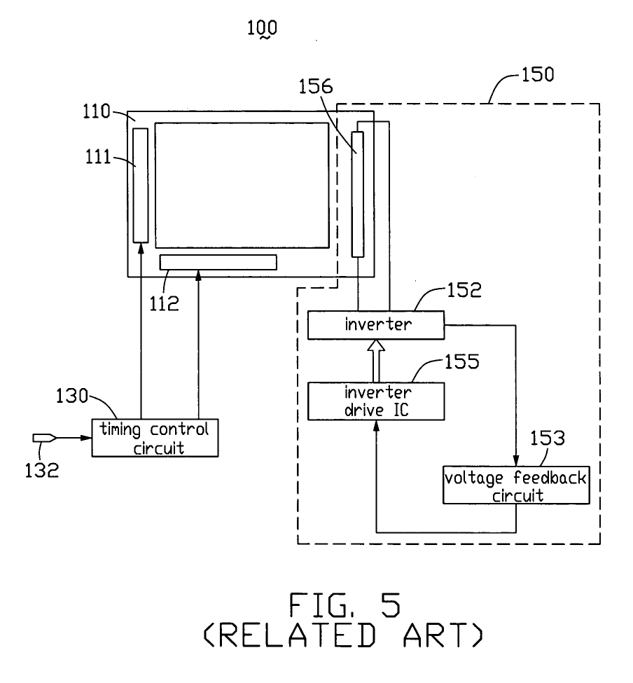

As shown in FIG. 4, an LCD according a third embodiment of the present invention is essentially an alternative embodiment of the first embodiment described above. The difference is that in the third embodiment, a PLL circuit 457 receives a timing control signal from a timing control circuit 430, and provides a backlight synchronized signal to an inverter drive IC 455 according to the timing control signal.

It is to be understood, however, that even though numerous characteristics and advantages of preferred embodiments have been set out in the foregoing description, together with details of the structures and functions of the embodiments, the disclosure is illustrative only; and that changes may be made in detail, especially in matters of shape, size, and arrangement of parts within the principles of the present invention to the full extent indicated by the broad general meaning of the terms in which the appended claims are expressed.

What is claimed is:

1. A liquid crystal display comprising:
a liquid crystal display panel comprising a gate drive integrated circuit and a data drive integrated circuit, which are configured for driving the liquid crystal display panel;
a timing control circuit configured for receiving a synchronized input signal, and generating a timing control signal for controlling the gate drive integrated circuit and the data drive integrated circuit according to the synchronized input signal; and
a backlight module, comprising:
a backlight;
an inverter configured for generating a backlight driving signal for driving the backlight;
an inverter drive integrated circuit;
a voltage feedback circuit configured for transmitting a voltage width message of the backlight driving signal back to the inverter drive integrated circuit;
a phase feedback circuit; and
a phase locked loop (PLL) circuit configured for receiving the synchronized input signal, receiving a frequency message of the backlight driving signal via the phase feedback circuit, and providing a backlight synchronized signal to the inverter drive integrated circuit according to the synchronized input signal and the frequency message of the backlight driving signal, the inverter drive integrated circuit being configured for controlling a frequency of the backlight driving signal according to the backlight synchronized signal.

2. The liquid crystal display as claimed in claim 1, wherein the PLL circuit comprises a phase focus, a phase comparator, and a voltage controlled oscillator (VCO), the phase focus is configured for receiving the frequency message of the backlight driving signal via the phase feedback circuit, generating a phase-division signal according to the frequency message of the backlight driving signal, and supplying the phase-division signal to the phase comparator, the phase comparator is configured for generating an adjusting signal according to a result of comparing the phase-division signal with the synchronized input signal, and supplying the adjusting signal to the VCO, and the VCO is configured for generating the backlight synchronized signal according to the adjusting signal, and supplying the backlight synchronized signal to the inverter drive integrated circuit.

3. The liquid crystal display as claimed in claim 2, wherein a frequency of the backlight synchronized signal is N times that of the phase-division signal, and a frequency of the phase-division signal is the same as that of the synchronized input signal, N being a positive whole number.

4. The liquid crystal display as claimed in claim 3, wherein the phase focus comprises a frequency control terminal configured for changing a value of N.

5. The liquid crystal display as claimed in claim 3, wherein a value of N is in the range from 1-20.

6. A liquid crystal display comprising:
a liquid crystal display panel comprising a gate drive integrated circuit and a data drive integrated circuit, which are configured for driving the liquid crystal display panel;
a timing control circuit configured for receiving a synchronized input signal, and generating a timing control signal for controlling the gate drive integrated circuit and the data drive integrated circuit according to the synchronized input signal; and
a backlight module, comprising:
a backlight;
an inverter configured for generating a backlight driving signal for driving the backlight;
a phase feedback circuit; and
an inverter drive integrated circuit comprising a phase locked loop (PLL) circuit configured for receiving a frequency message of the backlight driving signal via the phase feedback circuit and receiving the synchronized input signal, the inverter drive integrated circuit being configured for controlling a frequency of the backlight driving signal according to the backlight synchronized signal; and
a voltage feedback circuit configured for transmitting a voltage width message of the backlight driving signal back to the inverter drive integrated circuit.

7. The liquid crystal display as claimed in claim 6, wherein the PLL circuit comprises a phase focus, a phase comparator, and a voltage controlled oscillator (VCO), the phase focus is configured for receiving a frequency message of the backlight driving signal via the phase feedback circuit, generating a phase-division signal according to the frequency message of the backlight driving signal, and supplying the phase-division signal to the phase comparator, the phase comparator is configured for generating an adjusting signal according to a result of comparing the phase-division signal with the synchronized input signal, and supplying the adjusting signal to the VCO, and the VCO is configured for generating a backlight synchronized signal according to the adjusting signal, and supplying the backlight synchronized signal to the inverter drive integrated circuit.

8. The liquid crystal display as claimed in claim 7, wherein the inverter drive integrated circuit further comprises a pulse width modulation (PWM) circuit configured for driving the inverter, a triangular pulse generator, and a controller, the PLL circuit is configured for providing the backlight synchronized signal to the triangular pulse generator, the triangular pulse generator is configured for generating a triangular pulse signal according to the backlight synchronized signal, and supplying the triangular pulse signal to the controller, and the controller is configured for driving the PWM circuit according to the triangular pulse signal.

9. The liquid crystal display as claimed in claim 8, wherein a frequency of the backlight synchronized signal is N times that of the phase-division signal, and a frequency of the phase-division signal is the same as that of the synchronized input signal, N being a positive whole number.

10. The liquid crystal display as claimed in claim 9, wherein the phase focus comprises a frequency control terminal configured for changing a value of N.

11. The liquid crystal display as claimed in claim 9, wherein a value of N is in the range from 1-20.

12. A liquid crystal display comprising:
a liquid crystal display panel comprising a gate drive integrated circuit and a data drive integrated circuit, which are configured for driving the liquid crystal display panel;
a timing control circuit configured for receiving a synchronized input signal, and generating a timing control signal for controlling the gate drive integrated circuit and the data drive integrated circuit according to the synchronized input signal; and
a backlight module, comprising:
a backlight;
an inverter configured for generating a backlight driving signal for driving the backlight;
an inverter drive integrated circuit;
a voltage feedback circuit configured for transmitting a voltage width message of the backlight driving signal back to the inverter drive integrated circuit;
a phase feedback circuit; and
a phase locked loop (PLL) circuit configured for receiving the timing control signal from the timing control circuit, receiving a frequency message of the backlight driving signal via the phase feedback circuit, and providing a backlight synchronized signal to the inverter drive integrated circuit according to the timing control signal and the frequency message of the backlight driving signal, the inverter drive integrated circuit being configured for controlling a frequency of the backlight driving signal according to the backlight synchronized signal.

13. The liquid crystal display as claimed in claim 12, wherein the PLL circuit comprises a phase focus, a phase comparator, and a voltage controlled oscillator (VCO), the phase focus is configured for receiving the frequency message of the backlight driving signal via the phase feedback circuit, generating a phase-division signal according to the frequency message of the backlight driving signal, and supplying the phase-division signal to the phase comparator, the phase comparator is configured for generating an adjusting signal according to a result of comparing the phase-division signal with the synchronized input signal, and supplying the adjusting signal to the VCO, and the VCO is configured for generating the backlight synchronized signal according to the adjusting signal, and supplying the backlight synchronized signal to the inverter drive integrated circuit.

14. The liquid crystal display as claimed in claim 13, wherein a frequency of the backlight synchronized signal is N times that of the phase-division signal, and a frequency of the phase-division signal is the same as that of the synchronized input signal, N being a positive whole number.

15. The liquid crystal display as claimed in claim 14, wherein the phase focus comprises a frequency control terminal configured for changing a value of N.

17. The liquid crystal display as claimed in claim 14, wherein a value of N is in the range from 1-20.
